(19) United States
(12) Patent Application Publication
(10) Pub. No.: US 2013/0059682 A1
(43) Pub. Date: Mar. 7, 2013

(54) FUMBLE CAUSING TRAINING DEVICE FOR FOOTBALL

(71) Applicant: Neil F. Gilman, South Glastonbury, CT (US)

(72) Inventor: Neil F. Gilman, South Glastonbury, CT (US)

(73) Assignee: Marty Gilman, Inc, Gilman, CT (US)

(21) Appl. No.: 13/226,451

(22) Filed: Sep. 6, 2011

(51) Int. Cl. A63B 69/00; B23P 17/00

(52) U.S. Cl. 473/438; 29/530

(57) ABSTRACT

A training device 10 is disclosed, which includes a ball 12 and a biasing member 14, where a distal portion of the ball 13 is connected to a proximate end 15 of the biasing member 14. A support member 16 is connected to a distal end 18 of the biasing member 14, where the support member 16 is adapted for being connected to a stationary support structure 19. From this configuration, the ball 12 is capable of deflecting from an initial, rest configuration when the ball 12 is perturbed by clubbing, punching and/or chopping, and rapidly returning to the rest configuration after the perturbation.

### BACKGROUND

1. Field Of The Disclosed Embodiments

The disclosed embodiments relate to a training device which enables football players the opportunity to practice a fumble causing technique called “stripping the football.”

2. Background Of The Disclosed Embodiments

Various systems exist for assisting in training athletes of all ages in American football. Example training systems include: inflated footballs of various sizes, from junior to regulation; a solid football mounted to a stick or, alternatively, connected to a string, simulating the “snap” of a football; a “whiffle” football with an elastic cord attachment for throwing and catching practice; and a “heavy football,” that is, a weighted football, filled with water or metal pellets, for long “snapper” practice.

One football technique for which practice is sought is “stripping the football,” causing an opposing teammate to “fumble.” Stripping practice, using proper training systems, is an essential part of the mental and physical football game. Defensive coaches constantly talk about “see the football-cause a fumble” and “increasing take-aways,” that is, increase the number of fumbles. Coaches preach about such goals in team meetings, during video breakdown sessions, and during strength and conditioning sessions. Coaches believe in repetitive stripping drills to make certain techniques a habit.

A common training system for stripping a ball includes several components. One component is a solid or inflated football with Velcro™, re-connectable tape, sewn to its side. The other component is a “dummy” or foam filled “arm,” to which the football can stick via the tape. These components provide “stripping” practice because when the ball is hit, it separates from the dummy or arm and becomes loose. Relying on a stand-up or pop-up dummy, or on artificial arms can be a challenge in a training environment. In addition, relying on tape to hold the football to the system, such as with the dummy and artificial arms, can be a further challenge for a training environment.

### SUMMARY OF THE DISCLOSED EMBODIMENTS

A training system for football stripping is provided that can be mounted to a wall, a door, a table or a rack in the weight-room. With such a system, a football player can come out of a team meeting, a video breakdown session, or a strength and conditioning workout, and practice “clubbing”, “punching” or “chopping” the football to create a fumble.

### BRIEF DESCRIPTION OF THE FIGURES

Certain embodiments will be described through the use of the accompanying drawings, which are not to be considered as limiting, and in which:

FIG. 1 is a cross sectional view of the disclosed football training device;

FIG. 2 is an exploded view of components of the disclosed football training device;

FIG. 3 is an illustration of a component of the disclosed football training device;

FIG. 4 is an illustration of the football training device installed on a wall;

FIG. 5 is an illustration of the football training device installed on a block wall;

FIG. 6 is an illustration of the football training device installed on a rack; and

FIG. 7 is an illustration of a method of manufacturing the football training device.

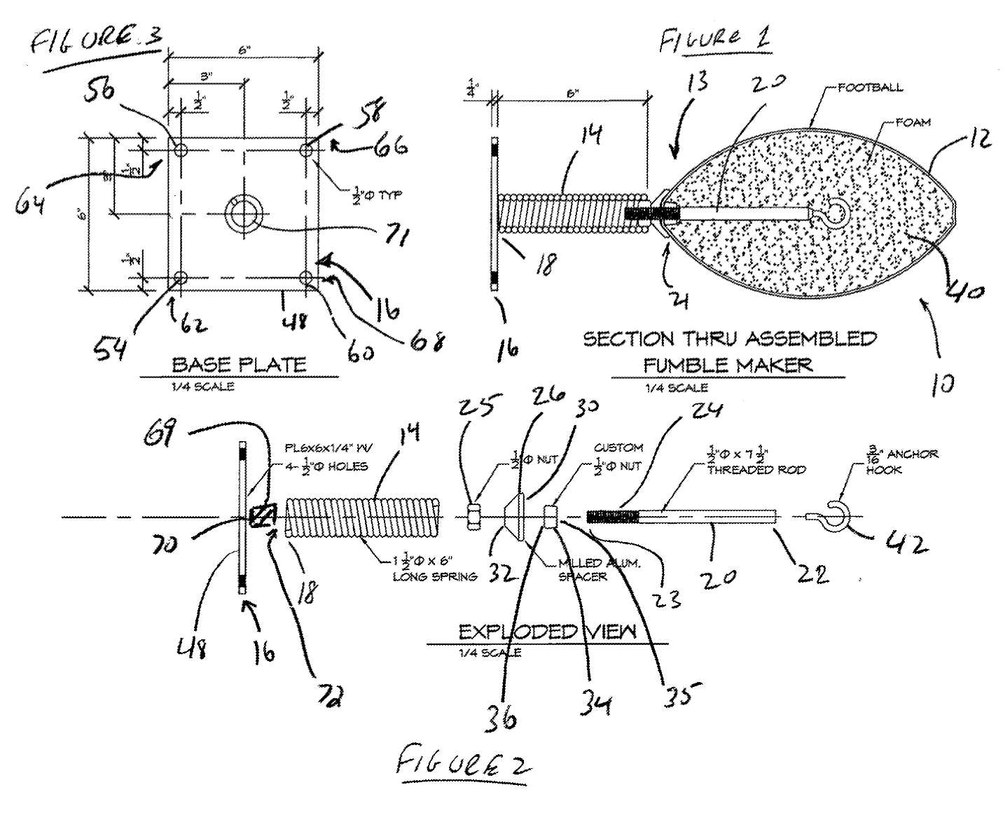

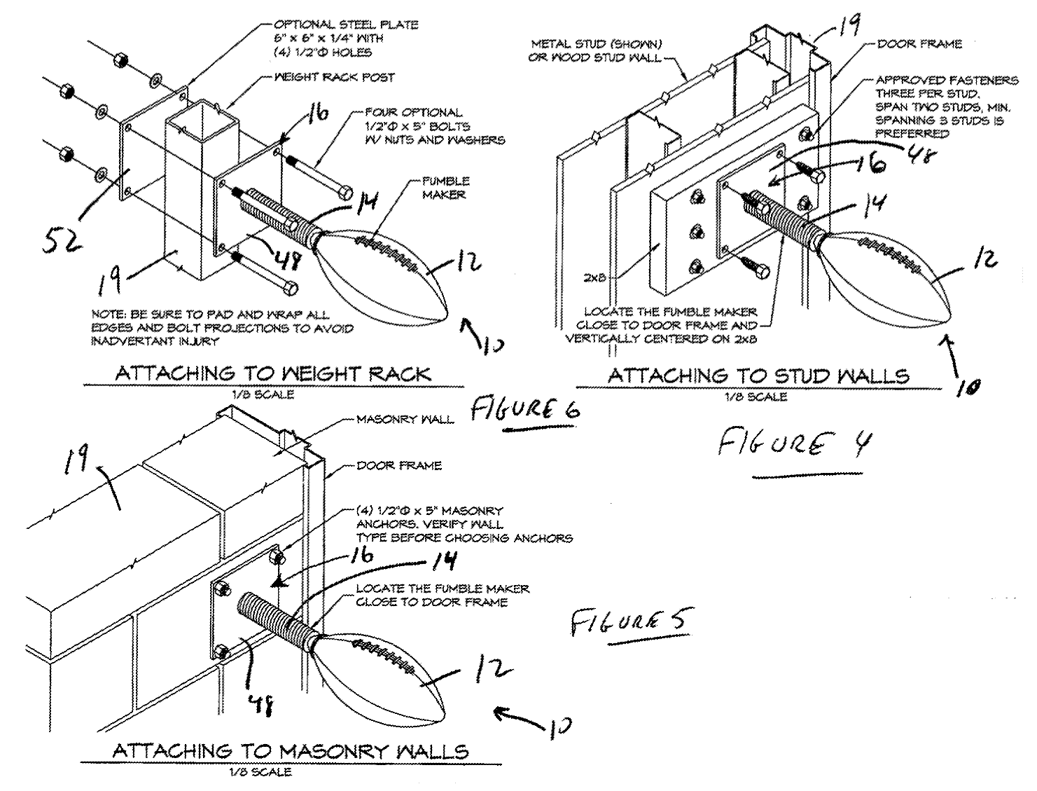

### DETAILED DESCRIPTION OF THE DISCLOSED EMBODIMENTS

A training device 10 is disclosed in the figures. The device includes a ball 12 and a biasing member 14, where a distal portion 13 of the ball 12 is connected to a proximate end of the biasing member 14. In the figures, the relative placement of “proximate” and “distal” is illustrate right to left. However, other relative directional relationships are acceptable.

A support member 16 is connected to a distal end 18 of the biasing member 14, where the support member 16 is adapted for being connected to a stationary support structure 19. From this configuration, the ball 12 is capable of deflecting from an initial, rest configuration when the ball 12 is perturbed by clubbing, punching and/or chopping, and rapidly returning to the rest configuration, substantially immediately after the perturbation.

As illustrated, the ball 12 is oblong shaped, and, in particular, is a football. The illustrated football is intended to depict a regulation size football, but other sizes are acceptable, such as a junior size. In addition, other ball shapes could be utilized without departing from the scope of the disclosed embodiments.

The biasing member 14 is a spring and, more specifically, a coil spring. In addition, the illustrated coil spring is a tension spring having an inch and a half diameter and is six inches long. The spring is a “heavy” spring having damping qualities. From the selection of the spring, the system can be over-damped, under-damped or critically damped, such that ball 12 experiences minimal or substantially no repeated undulations following the perturbation. Such motion control over the ball 12 enables rapid and repeated athletic training.

The ball 12 is connected to the spring 14 via a rod 20 extending therebetween. The rod 20 is illustrated as a half inch diameter steel rod which is seven and a half inches long. The rod 20 serves to facilitate a stable and reliable connection between the ball 12 and the spring 14, preventing the ball from breaking away during use.

As illustrated in the figures, the ball 12 is filled with polyurethane foam 40. In addition, the proximate end 22 of the rod 20 extends into the ball and has an anchoring member 42, illustrated as a hook, which is a three-sixteenth of an inch anchor, for securing the rod 20 to the foam 40. As can be appreciated, the rod 20 is threaded at its proximate end to receive the male threaded anchor. Further, as illustrated, the seven and a half inch long rod is long enough to position the anchor substantially halfway into the ball 12.

The disclosure will now address, more specifically, the connection between the rod and the spring at the distal portion of the ball. The ball 12 has an opening 21, which is illustrated as a three-quarter inch opening, allowing the rod 20 to pass therethrough along a rod-axial direction. The opening/hole 21 can be drilled into the apex of the football during manufacturing. A proximate end 22 of the rod 20 extends into the ball opening 21 and a distal end 23 of the rod 20 extends into the proximate end 15 of the spring 14. As can be appreciated, this configuration bridges the ball 12 with the spring 14.

The distal end 23 of the rod 20 has a threaded portion 24, and the proximate end 15 of the spring 14 includes a nut 25, illustrated as a half inch steel nut 25, fixed thereto, such as by welding, for receiving the threaded portion 24 of the rod 20. From this connection, the rod 20 will not fall away from the spring but instead forms an essentially integrated connection.

A spacer 26, milled from one and a half inch aluminum bar stock, is threaded to the threaded portion of the rod 20. A distal surface 32 of the spacer 26 is disposed against the nut and a proximate surface 30 of the spacer 26 is disposed against the exterior of the distal portion 13 of the ball 12. In other words, the spacer 26 is threaded so that it is positioned tightly against the ball 12. From this configuration, the ball opening 21 is capped from the ball exterior side.

The proximate surface 30 of the spacer 26 is contoured to provide a substantially complementary seating to the exterior of the distal portion 13 of the ball 12 disposed about the rod 20. As the spacer 26 is substantially more rigid than the ball 12, this complementary shape prevents unwanted deformation of the ball 12 in the area of the spacer 26.

A bushing 34, illustrated as a three-quarter-inch steel nut, which is substantially the same as the diameter of the ball opening 21, is threaded to the threaded portion 24 of the rod 20. A proximate surface 35 of the bushing 34 faces the interior of the ball 12 and a distal surface 36 of the bushing faces the exterior of the ball and is substantially planar with the opening 21 of the ball 12.

The distal surface 36 of the bushing 34 is contoured to provide a complementary seating to the proximate surface 30 of the spacer 26. From this complimentary configuration, the spacer 26 has a base to press against during assembly of the training device 10, enabling a tightly, and therefore reliably, threaded connection between the spacer 26 and the ball 12.

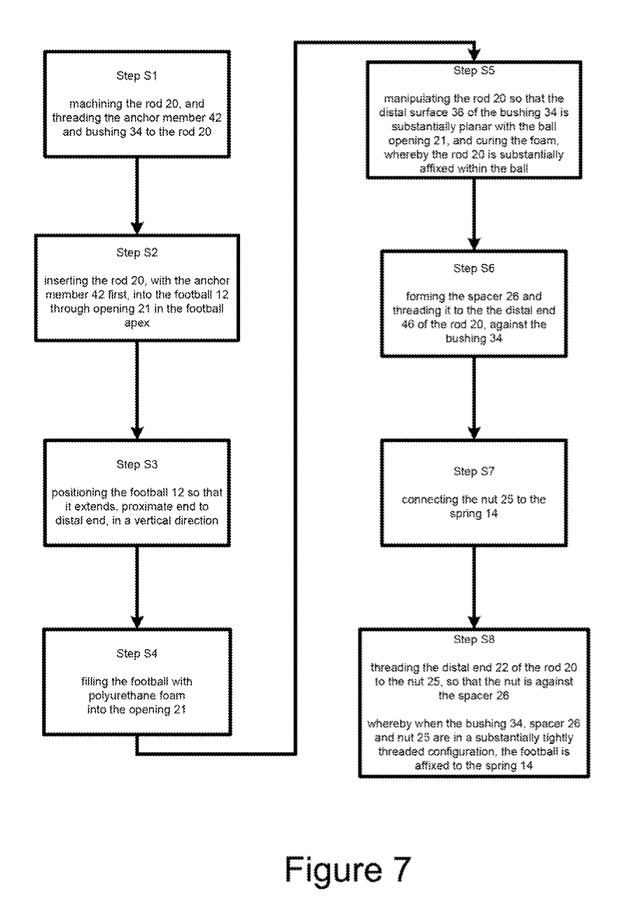

Turning momentarily to the manufacturing process illustrated in FIG. 7, the process includes a first step, Step S1, of machining the rod 20, and threading the anchor member 42 and bushing 34 to the rod 20 so as to form an anchor rod. The second step, Step S2, includes inserting the rod 20, anchor member 42 first, into the football 12 through the previously created opening 21 in the football apex.

For inserting the rod 20 into the ball 12, a guide tool (not illustrated) which can be used includes a guide cord, manufactured from braided nylon cord, which is directly tethered to a three-quarters of an inch outer diameter plug, to which a three-eighths of an inch fully male-threaded rod is threaded or otherwise fastened. The three-eighths of an inch diameter male threaded guide tool rod is screwed into the top of the anchor rod 20 which is drilled and tapped to receive the guide tool rod.

A third step, Step S3, includes positioning the football 12, for example, in a jig (not illustrated), so that the opening 21 faces vertically upward. At this time, the guide tool holds the rod 20 from falling into the vertically oriented football 12.

The fourth manufacturing step, Step S4, is filling the football 12 with polyurethane foam, such as through a funnel (not illustrated), via the opening 21. The fifth step, Step S5, is manipulating the rod 20 using the guide tool, so that the distal surface 36 of the bushing 34 is substantially planar with the ball opening 21. In this configuration, the hole 21 is “plugged” and the foam is allowed to cure, and, due to the anchor member 42, the rod 20 permanently fixed within the football 12. Once cured, the guide tool is removed.

The manufacturing process includes a sixth step, Step S6, of forming the spacer 26 and threading it to the distal end 22 of the rod 20, against the bushing 34. A seventh step, Step S7, is connecting the nut 25 to the spring 14 via, for example, welding. An eighth step, Step S8, is threading the distal end 22 of the rod 20 to the nut 25, so that the nut 25 is against the spacer 26. Once the bushing 34, spacer 26 and nut 25 are in a substantially tightly threaded configuration, the football is essentially integrally affixed to the spring 14.

Turning back to the device configuration, the disclosed support member 16 includes a plate 48, illustrated as a six inch square by quarter inch thick steel plate. The front-view plane of the plate 48 is perpendicular to a long axis of the spring 14. The plate 48 is capable of being connected to a substantially planar portion of the support structure 19. Examples of contemplated support structures 19 include doors, rigid walls, such as block walls (FIG. 5), plates on a wall which extend between support beams and studs (FIG. 4), plates between free standing supports such as weight-racks, etc. That is, the plate should be connected to a structure which will not give under the stress and strain from use of the device 10.

As illustrated in FIG. 5, the aforementioned plate 48 is a proximate plate, and the device includes a distal plate 52. The plane of the distal plate 52 is substantially parallel to the proximate plate 48. The plates 48, 52 are capable of sandwiching a support structure 19 there-between for supporting the device 10. Types of support structures which are considered include free standing gym racks, cantilevered posts, etc.

The plates 48, 52 have at least one opening 54, illustrated as a half inch diameter opening. The opening 54 is used for receiving a respective at least one bolt and securing the plates 48, 52 to or about a support structure 19. As illustrated, the at least one opening 54 includes a bank of four openings 54-60 on each plate, with one of the openings disposed at each of four corners of the plate 62-68. In the illustration, the openings are five inches on center for the six inch-square plate.

The support member 16 includes a second rod 69, serving as a support rod, which is illustrated as a one inch diameter rod, that is half an inch long, and connected at its distal end 70 to a center 71 of the proximate plate 48. The distal end 18 of the spring 14 is connected, via welding, to at least the proximate end 72 of the second rod 50 for supporting the spring 14 at the plate 48. With this connection, the spring is integrated to the plate and will not separate therefrom under loading stress.

It is within the scope of the disclosed embodiments to have a system that includes a support structure 19, such as a weight-rack, coupled with the training device. In such a system, the plates 48, 52 are secured about a portion of the support structure 19, such as to a weight-rack post, for securing the training device 10 thereto. That is, the disclosed embodiments are not limited to the football training device 10, removed from its typical application.

In sum, the disclosed embodiments relate to a football training device which includes a polyurethane foam filled football, with an anchor rod that is augured into the football. At the end of the rod is a threaded section that screws into a coil spring. In turn, the coil spring is threaded into a bushing that is welded to a steel plate. As indicated, the coil tension spring is strong enough to hold the football at angle perpendicular to the ground without bending; is strong enough to return the football to a perpendicular position after being clubbed, chopped or punched; and is not so stiff that it requires an unnatural amount of force to deflect it when performing “clubbing”, “chopping” or “punching” football techniques.

As further disclosed, the single steel plate can be used as a mounting plate for a wall, door or table. A double steel plate can be used as a mounting bracket with four locking bolts for a square or rectangular rack of the type typically found in a weight-room.

Accordingly, the disclosed embodiments enable the practice of ball stripping without relying on a stand-up or pop-up dummy, or artificial arms. In addition, tape is not relied upon to hold the football to the system. That is, the disclosed embodiments provide a training system for football stripping that can be mounted to a wall, a door, a table or a rack in the weight-room. With such a system, a football player can come out of a team meeting, a video breakdown session, or a strength and conditioning workout, and practice “clubbing”, “punching” or “chopping” the football to create a fumble.

The disclosed embodiments may be configured in other specific forms without departing from the spirit or essential characteristics identified herein. The embodiments are in all respects only as illustrative and not as restrictive. The scope of the embodiments is, therefore, indicated by the appended claims and their combination in whole or in part rather than by the foregoing description. All changes that come within the meaning and range of equivalency of the claims are to be embraced within their scope.

We claim:

1. A training device, comprising:
a ball and a biasing member, where a distal portion of the ball is connected to a proximate end of the biasing member; and
a support member connected to a distal end of the biasing member, where the support member is adapted for being connected to a stationary support structure;
whereby the ball is capable of deflecting from an initial, rest configuration when the ball is perturbed, by clubbing, punching and/or chopping, and rapidly returning to the rest configuration after the perturbation.

2. The training device of claim 1, where the ball is oblong shaped.

3. The training device of claim 2, where the ball is a football.

4. The training device of claim 1, where the basing member is a spring.

5. The training device of claim 4, where the basing member is a coil spring.

6. The training device of claim 5, where the coil spring is a tension spring.

7. The training device of claim 4, where the system is over-damped, under-damped or critically damped, whereby the ball experiences minimal or substantially no repeated undulations following the perturbation.

8. The training device of claim 5, wherein the ball is connected to the spring via a rod extending therebetween.

9. The training device of claim 8, where the ball is filled with polyurethane foam.

10. The training device of claim 15, where the proximate end of the rod extends into the ball and has an anchoring member for securing the rod to the foam.

11. The training device of claim 10, where the anchoring member is a hook.

12. The training device of claim 10, where a proximate end of the rod, including the anchoring member, extends substantially halfway into the ball.

13. The training device of claim 10, wherein:
the distal portion of the ball has an opening; and
the proximate end of the rod extends into the ball opening and a distal end of the rod extends into the proximate end of the spring.

14. The training device of claim 13, where:
the distal end of the rod has a threaded portion, and the proximate end of the spring includes a nut fixed thereto for receiving the threaded portion of the rod.

15. The training device of claim 14, including:
a spacer, threaded to the threaded portion of the rod; and
a distal surface of the spacer is disposed against the nut and a proximate surface of the spacer is disposed against the exterior of the distal portion of the ball;
whereby the ball opening is capped from the ball exterior side.

16. The training device of claim 15, wherein the proximate surface of the spacer is contoured to provide a substantially complementary seating to the exterior of the distal portion of the ball disposed about the rod.

17. The training device of claim 16, including:
a bushing, having an outer shape enabling it to pass through the ball opening, is threaded to the threaded portion of the rod; and
a proximate surface of the bushing faces the interior of the ball and a distal surface of the bushing faces the ball exterior and is substantially planar with the ball opening.

18. The training device of claim 17, wherein the distal surface of the bushing is contoured to provide a complementary seating to the proximate surface of the spacer, enabling a tightly threaded connection between the ball and the spacer.

19. The training device of claim 10, where:
the support member includes a plate;
a plane of the plate is perpendicular to a long axis of the spring; and
the plate is capable of being connected to a substantially planar portion of a support structure.

20. The training device of claim 19, where:
the plate is a proximate plate, and the device includes a distal plate;
a plane of the distal plate is substantially parallel to the proximate plate; and
the plates are capable of sandwiching a support structure therebetween for supporting the device.

21. The training device of claim 20, where the plates have at least one opening 54 for receiving a respective at least one bolt and securing the plates to or about a support structure.

22. The training device of claim 21, where the at least one opening 54 includes a bank of four openings on each plate, with one of the openings disposed at each of four corners of the plate.

23. The training device of claim 22, where:
the support member includes a second rod connected at its distal end to a center of the plate; and
the distal end of the spring is connected to at least a proximate end of the second rod for supporting the spring at the plate.

24. A system including a support structure and the training device of claim 20, where the plates are secured about a portion of the support structure for securing the training device thereto.

25. A method of manufacturing the training device of claim 18, comprising:
machining the rod, and threading the anchor member and bushing to the rod;
inserting the rod, anchor member first, into the football through the opening in the football apex;
positioning the football so that the opening extends upwardly;
filling the football with polyurethane foam via the opening;
manipulating the rod so that the distal surface of the bushing is substantially planar with the ball opening, and curing the foam, whereby the rod is substantially permanently affixed within the ball;
forming the spacer and threading it to the distal end of the rod, against the bushing;
connecting the nut to the spring;
threading the distal end of the rod to the nut, so that the nut is against the spacer;
whereby when the bushing, spacer and nut are in a substantially tightly threaded configuration, the football is affixed to the spring.
